(19) United States
(12) Patent Application Publication
(10) Pub. No.: US 2015/0184844 A1
(43) Pub. Date: Jul. 2, 2015

(54) INFLATABLE DISPLAY WITH DYNAMIC LIGHTING EFFECT

(71) Applicant: Gemmy Industries Corporation, Coppell, TX (US)

(72) Inventor: Cheng-Chun Zhang, Shenzhen City (CN)

(73) Assignee: Gemmy Industries Corporation, Coppell, TX (US)

(21) Appl. No.: 14/145,512

(22) Filed: Dec. 31, 2013

(51) Int. Cl. F21V 33/00; F21V 5/00; F21V 5/04; F21V 17/02; F21K 99/00; F21V 31/04; F21V 13/02

(52) U.S. Cl. CPC F21V 33/0028; F21V 31/04; F21V 5/00; F21V 13/02; F21V 17/02; F21K 9/30; F21V 5/04; F21Y 2101/02

(57) ABSTRACT

An inflatable display with dynamic lighting effect has an inflatable body, an air pump inflating the inflatable body, and a lighting assembly mounted inside the inflatable body for providing dynamic lighting variations. The lighting assembly has a light housing, a power supply, a lighting module, and a refracting module mounted in the light housing. The lighting module and the refracting module rotate relative to each other. As light beams emitted from the lighting module pass through the refracting module, the light beams are mixed and refracted. With relative rotation of the lighting module and the refracting module, the light beams can project outwards to further penetrate through the inflatable body at different angles covering a large area to form the dynamic lighting variations and to exhibit the dynamic lighting effect.

### BACKGROUND OF THE INVENTION

1. Field of the Invention

The present invention relates to an inflatable display, especially to an inflatable display with dynamic lighting effect.

2. Description of the Prior Art(s)

Inflatable displays are normally used for occasions of all kinds of exhibitions, carnivals, and parties. Based on means of application and displaying, the inflatable displays can be classified into a stationary type and a wearable type. The stationary type of inflatable displays pertains to inflatable displays that are fixedly mounted in fields of the foregoing occasions. The wearable type of inflatable displays pertains to outfits that are worn by performers for purpose of decoration, advertisement, and entertainment.

A conventional inflatable display has an inflatable body and an air pump for inflating the inflatable body. As the conventional inflatable display is not luminous, entertaining and decorative effects of the conventional inflatable display are limited. Moreover, since many activities, such as Halloween parties, are held in a dusky occasion with dim light, the conventional inflatable display does not fit the dusky occasion.

In order to enhance the entertaining and the decorative effects of the conventional inflatable display, a lighting unit is mounted inside the inflatable body of the conventional inflatable display. However, the lighting unit only illuminates the conventional inflatable display, or flickers so as to generate lighting variations of the lighting unit. The lighting variations are limited and the entertaining and the decorative effects of the conventional inflatable displays are still not improved efficiently.

To overcome the shortcomings, the present invention provides an inflatable display with dynamic lighting effect to mitigate or obviate the aforementioned problems.

### SUMMARY OF THE INVENTION

The main objective of the present invention is to provide an inflatable display with dynamic lighting effect. The inflatable display has an inflatable body, an air pump inflating the inflatable body, and a lighting assembly mounted inside the inflatable body for providing dynamic lighting variations. The lighting assembly has a light housing, a power supply, a lighting module, and a refracting module mounted in the light housing. The lighting module and the refracting module rotate relative to each other.

As light beams emitted from the lighting module pass through the refracting module, the light beams are mixed and refracted. With relative rotation of the lighting module and the refracting module, the light beams can project outwards to further penetrate through the inflatable body at different angles covering a large area to form the dynamic lighting variations and to exhibit the dynamic lighting effect.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an inflatable display with dynamic lighting effect in accordance with the present invention;

FIG. 2 is a perspective view of a lighting assembly of the inflatable display in FIG. 1;

FIG. 3 is an exploded perspective view of the lighting assembly of the inflatable display in FIG. 1;

FIG. 4 is a side view in partial section of the lighting assembly of the inflatable display in FIG. 1;

FIG. 5 is a perspective view of a lighting assembly of a second embodiment of an inflatable display with dynamic lighting effect in accordance with the present invention; and

FIG. 6 is an exploded perspective view of the lighting assembly of the inflatable display in FIG. 5.

### DETAILED DESCRIPTION OF THE PREFERRED EMBODIMENTS

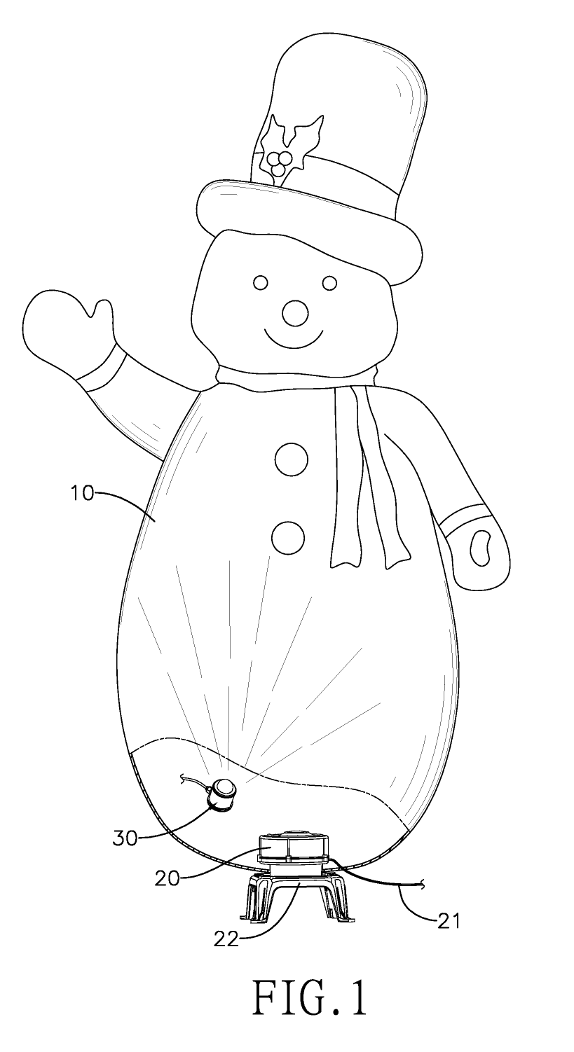

With reference to FIG. 1, in a first preferred embodiment, an inflatable display with dynamic lighting effect in accordance with the present invention comprises an inflatable body 10, an air pump 20, and a lighting assembly 30.

The inflatable body 10 is transparent and has an inner wall and an air inlet. The air inlet is formed through the inflatable body 10. Preferably, the air inlet is formed through a bottom of the inflatable body 10.

The air pump 20 is mounted to the air inlet of the inflatable body 10 and has a power cord 21. The power cord 21 of the air pump 20 is connected to an external power source, such as a mains power, to provide an operating power to the air pump 20 so as to inflate the inflatable body 10. Preferably, the air pump 20 is mounted on and supported by a seat 22. Alternatively, the operating power of the air pump 20 may be supplied from batteries.

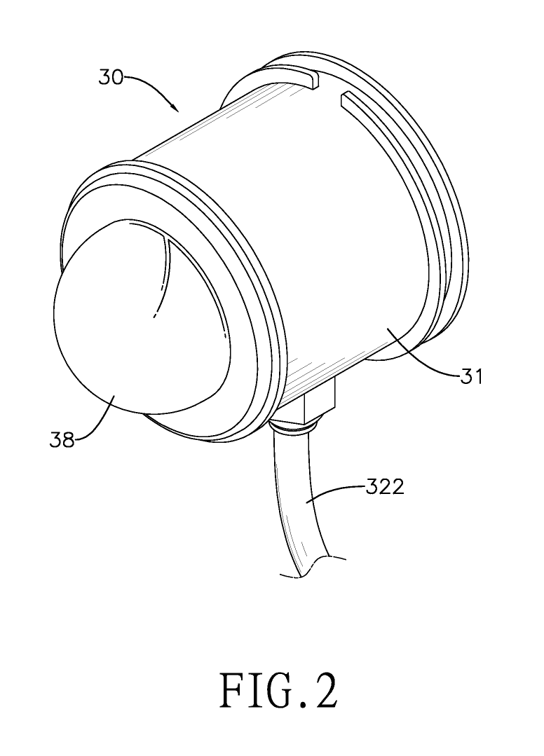

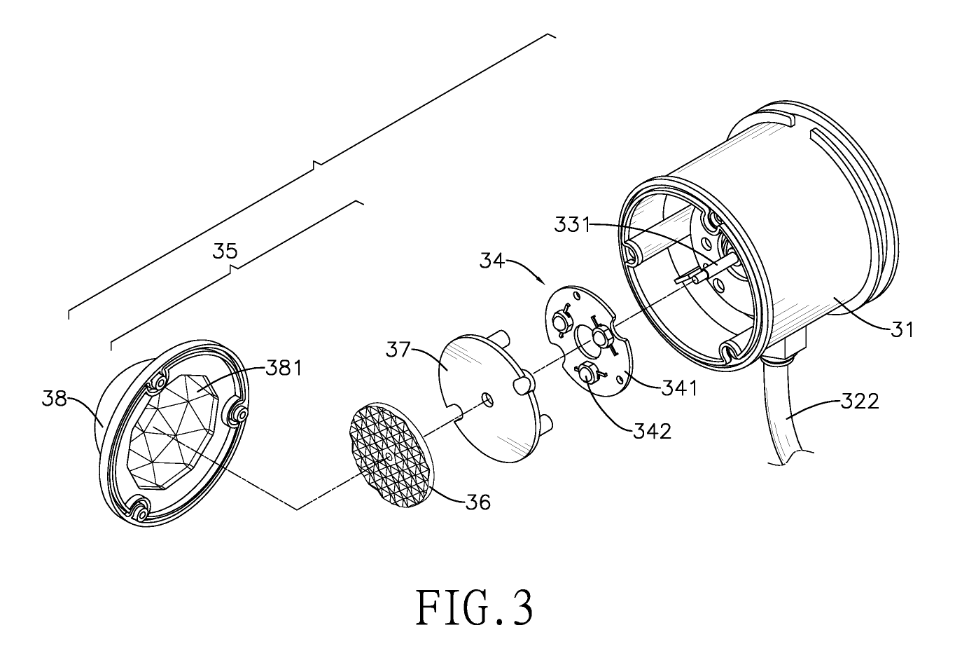

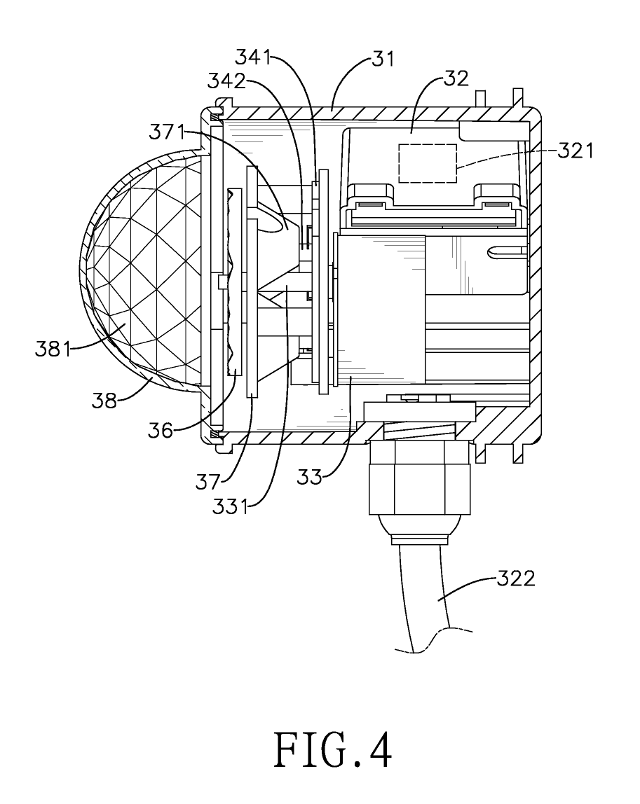

With further reference to FIGS. 2 to 4, the lighting assembly 30 is mounted in the inflatable body 10 on the inner wall of the inflatable body 10, and has a light housing 31, a power supply 32, a motor 33, a lighting module 34, a refracting module 35.

The light housing 31 is hollow and has a front open end and a rear closed end.

The power supply 32 is mounted in the light housing 31, and has a power adapter 321 and a power cord 322. The power adapter 321 converts alternating current (AC) to direct current (DC). The power cord 322 of the power supply 32 is electrically connected to the power adapter 321, extends out of the light housing 31, and is electrically connected to an external power source. Preferably, the power cord 322 of the power supply 32 is electrically connected with the power cord 21 of the air pump 20, and is connected to the external power source via the power cord 21 of the air pump 20.

The motor 33 is mounted in the light housing 31, is electrically connected to the power adapter 321 of the power supply 32, and has a driving shaft 331. The driving shaft 331 protrudes toward the front open end of the light housing 31, and is driven to rotate by the motor 31. The driving shaft 331 may continuously rotate in a specific direction or may rotate back and forth.

The lighting module 34 and the refracting module 35 rotate relative to each other. Specifically, in the first preferred embodiment, the lighting module 34 is mounted in the light housing 31, is electrically connected to the power adapter 321 of the power supply 32, is disposed between the front open end of the light housing 31 and the motor 33, and has a circuit board 341 and multiple light emitting diodes (LEDs) 342. The circuit board 341 is annular, is disposed around the driving shaft 331 of the motor 33, is electrically connected to the power adapter 321 of the power supply 32, and has a front surface and a control unit. The front surface of the circuit board 341 faces the front open end of the light housing 31. The LEDs 342 can emit light beams in different colors, are electrically mounted on the front surface of the circuit board 341 and are controlled by the control unit of the circuit board 341 so as to form a specific lighting mode, such as a flicker mode (each of the LEDs 342 flickers) or a normal mode (each of the LEDs 342 shines continuously).

The refracting module 35 is mounted on the front open end of the light housing 31. The refracting module 35 has a refractive lens 36, a condenser 37, and a light shade 38. The refractive lens 36 is disposed between the front open end of the light housing 31 and the lighting module 34, is securely attached to the driving shaft 331 of the motor 33, and is driven to rotate by the driving shaft 331 of the motor 31. The refractive lens 36 has a front surface. The front surface of the refractive lens 36 faces the front open end of the light housing 31, is irregular and rough, and includes multiple refractive surfaces being plane and inclining at different angles. The condenser 37 is disposed around the driving shaft 331 of the motor 33 and between the refractive lens 36 and the lighting module 34. The condenser 37 has a rear surface and multiple cone protrusions 371. The rear surface of the condenser 37 faces the lighting module 34. The cone protrusions 371 are separately formed on and protrude from the rear surface of the condenser 37, and respectively correspond in position to the LEDs 342 of the lighting module 34. The light shade 38 is hemispherical, caps the light housing 31, and is mounted on and securely attached to the front open end of the light housing 31. The light shade 38 has an inner surface and a beam-splitter lens portion 381. The beam-splitter lens portion 381 is formed on the inner surface of the light shade 38 and includes multiple convex lens units.

In use, the power cord 322 of the power supply 32 that is connected to the external power source transmits the AC to the power adapter 321, and the power adapter 321 converts the AC to the DC for supplying electrical power to the motor 33 and the lighting module 34.

Thus, the LEDs 342 emit light beams in different colors and the light beams penetrate through the cone protrusions 371 of the condenser 37. The cone protrusions 371 of the condenser 37 condense and then diffuse the light beams to allow the light beams from the LEDs 342 to further penetrate through the refractive lens 36. In the meantime, the refractive lens 36 is driven to rotate by the driving shaft 331 of the motor 33. As the light beams from the LEDs 342 pass through the refractive lens 36, the light beams in different colors are mixed and then further penetrate through the beam-splitter lens portion 381 of the light shade 38 to allow the light beams from the LEDs 342 to be refracted again by the convex lens units of the beam-splitter lens portion 381 of the light shade 38.

With flickering of the LEDs 342 and rotation of the refractive lens 36, the light beams that pass through the light shade 38 can project outwards to further penetrate through the inflatable body 10 at different angles covering a large area to form a dynamic lighting variation and to exhibit a dynamic lighting effect. Moreover, as mounting position of the lighting assembly 30 in the inflatable body 10 changes, the lighting effects created on the inflatable body 10 differs as well.

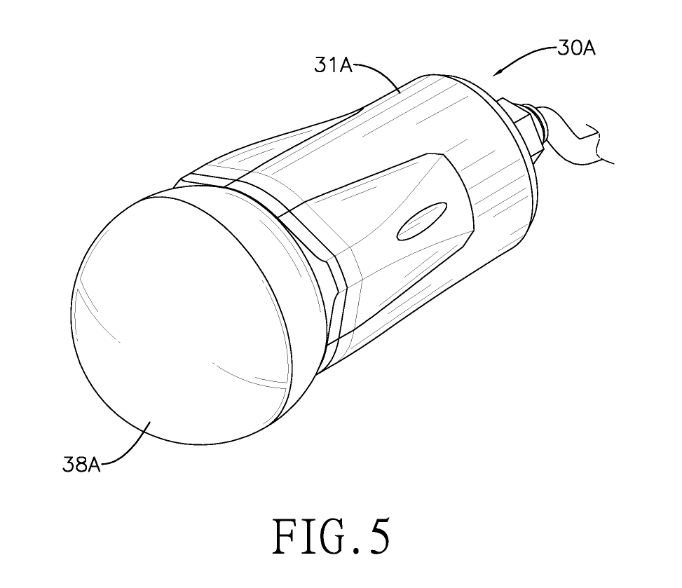

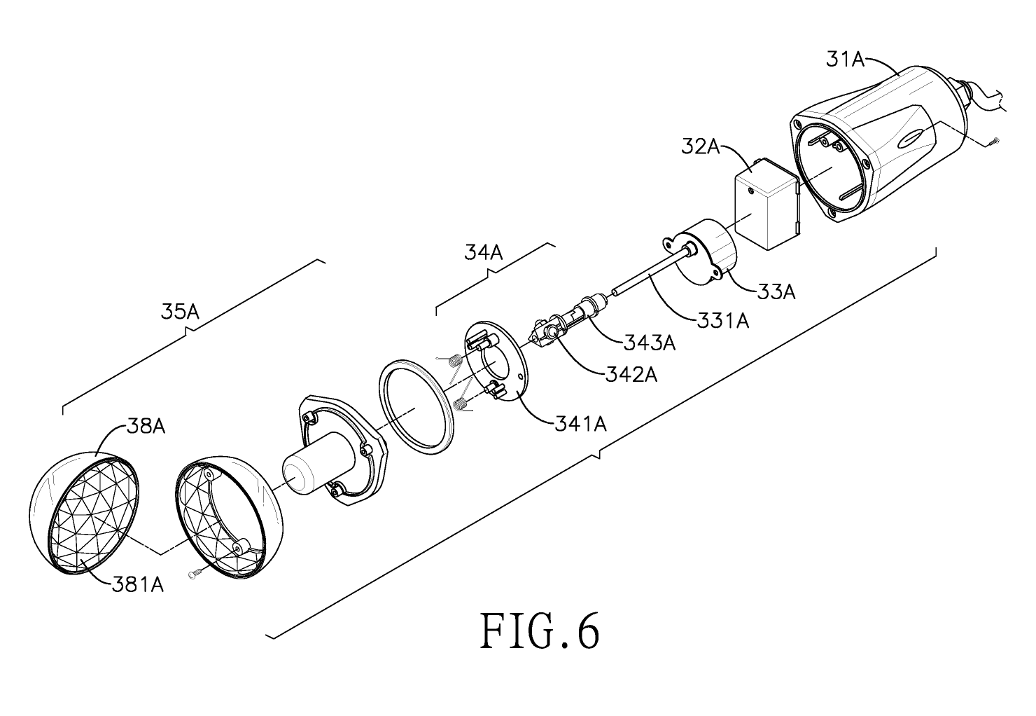

With reference to FIGS. 5 and 6, in a second preferred embodiment, the lighting module 34A of the lighting assembly 30A has an LED module 343A and a circuit board 341A. The LED module 343A is tubular, is mounted around and attached to the driving shaft 331A of the motor 33A, and is driven to rotate back and forth by the driving shaft 331A of the motor 33A. The LED module 343A has multiple LEDs 342A that can emit light beams in different colors. The circuit board 341A is annular, is disposed around the LED module 343A, and is electrically connected to the LED module 343A and the power supply 32A. The refracting module 35A of the lighting assembly 30A has a light shade 35A. The light shade 35A is spherical, is mounted on and securely attached to the front open end of the light housing 31A, and has an inner surface and a beam-splitter lens portion 381A. The beam-splitter lens portion 381A is formed on the inner surface of the light shade 38A and includes multiple convex lens units.

The light beams from the LEDs 342A penetrate through the beam-splitter lens portion 381A of the light shade 38A to allow the light beams from the LEDs 342A to be refracted by the convex lens units of the beam-splitter lens portion 381A of the light shade 38A. With flickering of the LEDs 342A and rotation of the LED module 343A, the lighting assembly 30A forms a dynamic lighting variation and exhibits a dynamic lighting effect.

The inflatable display with the dynamic lighting effect is entertaining irrespective of whether it is fixedly mounted on a site of an occasion or worn by a wearer, and can be more entertaining when used in a dusky occasion with dim light, such as a Halloween party. The inflatable display with the dynamic lighting effect has improved entertaining and decorative effects.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An inflatable display with dynamic lighting effect comprising:
an inflatable body being transparent and having an inner wall and an air inlet formed through the inflatable body;
an air pump mounted to the air inlet of the inflatable body; and
a lighting assembly mounted in the inflatable body on the inner wall of the inflatable body, and having
a light housing being hollow and having a front open end and a rear closed end;
a power supply mounted in the light housing;
a lighting module mounted in the light housing and electrically connected to the power supply; and
a refracting module mounted on the front open end of the light housing;
wherein the lighting module and the refracting module rotate relative to each other.

2. The inflatable display as claimed in claim 1, wherein
the lighting assembly further has a motor mounted in the light housing, disposed between the lighting module and the rear closed end of the light housing, and electrically connected to the power supply, and the motor has a driving shaft protruding toward the front open end of the light housing; and
the refracting module has
a refractive lens disposed between the front open end of the light housing and the lighting module, securely attached to the driving shaft of the motor, and driven to rotate by the driving shaft of the motor; and
a light shade mounted on and securely attached to the front open end of the light housing.

3. The inflatable display as claimed in claim 1, wherein
the lighting assembly further has a motor mounted in the light housing, disposed between the lighting module and the rear closed end of the light housing, and electrically connected to the power supply, and the motor has a driving shaft protruding toward the front open end of the light housing;
the lighting module is mounted on and is driven by the driving shaft of the motor; and
the refracting module has a light shade mounted on and securely attached to the front open end of the light housing, and the light shade has
an inner surface; and
a beam-splitter lens portion formed on the inner surface of the light shade and including multiple convex lens units.

4. The inflatable display as claimed in claim 2, wherein the refractive lens of the refracting module has a front surface facing the front open end of the light housing, being irregular and rough, and including multiple refractive surfaces, and the refractive surfaces of the refractive lens are plane and incline at different angles.

5. The inflatable display as claimed in claim 2, wherein the lighting module has
a circuit board being annular, disposed around the driving shaft of the motor, electrically connected to the power supply, and having
a front surface facing the front open end of the light housing; and
a control unit; and
multiple light-emitting diodes (LEDs) electrically mounted on the front surface of the circuit board and controlled by the control unit of the circuit board.

6. The inflatable display as claimed in claim 3, wherein the lighting module has
an LED module mounted around and attached to the driving shaft of the motor, and driven to rotate by the driving shaft of the motor, and the LED module having multiple LEDs; and
a circuit board being annular, disposed around the LED module, and electrically connected to the LED module and the power supply.

7. The inflatable display as claimed in claim 3, wherein the refracting module further has a refractive lens disposed between the front open end of the light housing and the lighting module, securely attached to the driving shaft of the motor, and driven to rotate by the driving shaft of the motor.

8. The inflatable display as claimed in claim 6, wherein the refracting module further has a refractive lens disposed between the front open end of the light housing and the lighting module, securely attached to the driving shaft of the motor, and driven to rotate by the driving shaft of the motor.

9. The inflatable display as claimed in claim 5, wherein the refracting module further has a condenser disposed around the driving shaft of the motor and between the refractive lens and the lighting module, and the condenser has
a rear surface facing the lighting module; and
multiple cone protrusions separately formed on and protruding from the rear surface of the condenser, and respectively corresponding in position to the LEDs of the lighting module.

10. The inflatable display as claimed in claim 2, wherein the light shade of the lighting module is hemispherical or spherical.

11. The inflatable display as claimed in claim 3, wherein the light shade of the lighting module is hemispherical or spherical.

12. The inflatable display as claimed in claim 4, wherein the light shade of the lighting module is hemispherical or spherical.

13. The inflatable display as claimed in claim 5, wherein the light shade of the lighting module is hemispherical or spherical.

14. The inflatable display as claimed in claim 7, wherein the light shade of the lighting module is hemispherical or spherical.

15. The inflatable display as claimed in claim 9, wherein the light shade of the lighting module is hemispherical or spherical.

16. The inflatable display as claimed in claim 7, wherein the refractive lens of the refracting module has a front surface facing the front open end of the light housing, being irregular and rough, and including multiple refractive surfaces, and the refractive surfaces of the refractive lens are plane and incline at different angles.

17. The inflatable display as claimed in claim 16, wherein the light shade of the lighting module is hemispherical or spherical.
